(19) United States
(12) Patent Application Publication
(10) Pub. No.: US 2020/0136505 A1
(43) Pub. Date: Apr. 30, 2020

(54) SWITCHED RESISTOR DC-DC CONVERTER

(71) Applicant: NXP B.V., Eindhoven (NL)

(72) Inventors: Harry Neuteboom, Eindhoven (NL); Bernardus Johannes Martinus Kup, Eindhoven (NL); Dave Sebastiaan Kroekenstoel, Eindhoven (NL)

(73) Assignee: NXP B.V., Eindhoven (NL)

(21) Appl. No.: 16/172,635

(22) Filed: Oct. 26, 2018

(51) Int. Cl. H02M 3/156; H02M 3/06; H02M 1/08

(52) U.S. Cl. CPC H02M 3/156; H02M 1/08; H02M 3/06

(57) ABSTRACT

Embodiments of DC-DC converters are disclosed. In an embodiment, a DC-DC converter includes a switched resistor connected between an input terminal of the DC-DC converter from which an input voltage is received and an output terminal of the DC-DC converter from which an output voltage is output and a comparator configured to compare the output voltage with a reference voltage and to switch on or off the switched resistor based on the comparison between the output voltage and the reference voltage.

### BACKGROUND

A direct current (DC)-DC converter can be used to convert an input DC voltage into a desired output DC voltage. Changes in the load current through a load of a DC-DC converter can affect the output voltage of the DC-DC converter. For example, a loadstep in the load current (e.g., an instantaneous increase of the load current) through a load of a DC-DC converter can cause an abrupt increase or decrease in the output voltage of the DC-DC converter. However, DC-DC converters, for example capacitive DC-DC converters, typically react to the abrupt increase or decrease their output voltage in a slow pace, which makes these DC-DC converters unsuitable for applications that require stable voltage.

### SUMMARY

Embodiments of DC-DC converters are disclosed. In an embodiment, a DC-DC converter includes a switched resistor connected between an input terminal of the DC-DC converter from which an input voltage is received and an output terminal of the DC-DC converter from which an output voltage is output and a comparator configured to compare the output voltage with a reference voltage and to switch on or off the switched resistor based on the comparison between the output voltage and the reference voltage. Other embodiments are also described.

In an embodiment, the switched resistor includes a transistor connected between the input terminal and the output terminal.

In an embodiment, a base terminal or a gate terminal of the transistor is connected to an output terminal of the comparator.

In an embodiment, the comparator is further configured to switch on the switched resistor for a clock period when the output voltage is lower than the reference voltage.

In an embodiment, the comparator is further configured to switch off the switched resistor for a clock period when the output voltage is higher than the reference voltage.

In an embodiment, the comparator is further configured to switch on or off the switched resistor based on the comparison between the output voltage and the reference voltage in response to a signal edge of a clock signal.

In an embodiment, the comparator is further configured to switch on or off the switched resistor for a clock period of the clock signal based on the comparison in response to the signal edge of the clock signal.

In an embodiment, the comparator is further configured to compare the output voltage with the reference voltage in response to a signal edge of a clock signal and to switch on or off the switched resistor for a clock period of the clock signal based on the comparison.

In an embodiment, the comparator is further configured to switch on the switched resistor for the clock period when the output voltage is lower than the reference voltage at the signal edge of the clock signal.

In an embodiment, the comparator is further configured to switch off the switched resistor for the clock period when the output voltage is higher than the reference voltage at the signal edge of the clock signal.

In an embodiment, the signal edge of the clock signal includes a rising signal edge or a falling signal edge.

In an embodiment, the DC-DC converter further includes a capacitor connected between the output terminal and a fixed voltage.

In an embodiment, a DC-DC converter includes a transistor connected between an input terminal of the DC-DC converter from which an input voltage is received and an output terminal of the DC-DC converter from which an output voltage is output and a comparator configured to compare the output voltage with a reference voltage in response to a signal edge of a clock signal and to switch on or off the transistor for a clock period of the clock signal based on the comparison between the output voltage and the reference voltage.

In an embodiment, the comparator is further configured to switch on the transistor for the clock period when the output voltage is lower than the reference voltage at the signal edge of the clock signal.

In an embodiment, the comparator is further configured to switch off the transistor for a clock period when the output voltage is higher than the reference voltage at the signal edge of the clock signal.

In an embodiment, a base terminal or a gate terminal of the transistor is connected to an output terminal of the comparator.

In an embodiment, the signal edge of the clock signal includes a rising signal edge or a falling signal edge.

In an embodiment, the DC-DC converter further includes a capacitor connected between the output terminal and a fixed voltage.

In an embodiment, a method for operating a DC-DC converter involves comparing an output voltage of the DC-DC converter with a reference voltage and switching on or off a switched resistor, which is connected between an input terminal of the DC-DC converter from which an input voltage is received and an output terminal of the DC-DC converter from which the output voltage is output, based on the comparison between the output voltage and the reference voltage.

In an embodiment, switching on or off the switched resistor based on the comparison between the output voltage and the reference voltage involves switching on the switched resistor for a first clock period when the output voltage is lower than the reference voltage at a first signal edge of the clock signal and switching off the switched resistor for a second clock period when the output voltage is higher than the reference voltage at a second signal edge of the clock signal.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 is a schematic block diagram of a DC-DC converter in accordance with an embodiment of the invention.

FIG. 2 depicts an embodiment of the DC-DC converter depicted in FIG. 1.

FIG. 3 illustrates a signal timing diagram that corresponds to an operation of the DC-DC converter depicted in FIG. 2.

FIG. 4 illustrates a signal timing diagram that corresponds to an operation of the DC-DC converter depicted in FIG. 2 in which a loadstep occurs.

FIG. 5 is a process flow diagram of a method for operating a DC-DC converter in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

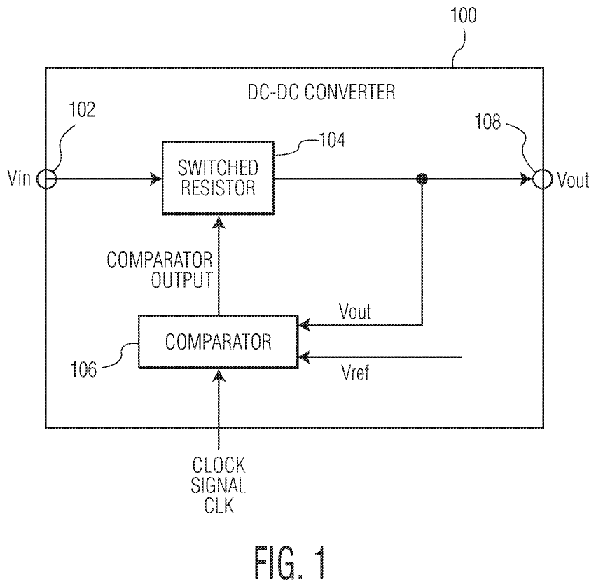

FIG. 1 is a schematic block diagram of a DC-DC converter 100 in accordance with an embodiment of the invention. The DC-DC converter converts an input DC voltage, Vᵢₙ, into a desired output DC voltage, Vₒᵤₜ. The DC-DC converter can be used in various applications, such as automotive applications, communications applications, industrial applications, medical applications, computer applications, and/or consumer or appliance applications. In the embodiment depicted in FIG. 1, the DC-DC converter includes an input terminal 102, a switched resistor 104, a comparator 106, and an output terminal 108. In some embodiments, the DC-DC converter is included in a computing device, such as a smartphone, a tablet computer, a laptop, etc. In some embodiments, the DC-DC converter is implemented in a substrate, such as a semiconductor wafer or a printed circuit board (PCB). In an embodiment, the DC-DC converter is packaged as a stand-alone semiconductor IC chip. Although the DC-DC converter is shown in FIG. 1 as including certain circuit elements, in other embodiments, the DC-DC converter may include one or more additional circuit elements. For example, the DC-DC converter may include a reference voltage generator configured to generate a reference voltage, V_{ref}, for the comparator. In another example, the DC-DC converter may include a clock signal generator configured to generate a clock signal, CLK, for the comparator.

The DC-DC converter 100 can deal with an abrupt increase or decrease in the output DC voltage, Vₒᵤₜ, of the DC-DC converter caused by a loadstep in the load current (e.g., an instantaneous increase of the load current) in a timely manner (within a clock period e.g., 1 microsecond for a one-megahertz (1 MHz) clock). When an instantaneous increase of the load current occurs, the DC-DC converter depicted in FIG. 1 can switch on the switched resistor when or immediately after (for example, within a clock period, e.g., 1 microsecond for a 1 MHz clock) the comparator detects a drop in the output DC voltage, Vₒᵤₜ. Compared to a typical DC-DC converter that reacts to an abrupt increase or decrease in its output voltage at a slow pace (e.g., by adjusting its impedance in small steps in multiple (e.g., more than 4) clock periods or cycles), the DC-DC converter depicted in FIG. 1 can adjust the output DC voltage, Vₒᵤₜ, (e.g., to keep the output DC voltage, Vₒᵤₜ, stable) more quickly. Consequently, the DC-DC converter depicted in FIG. 1 can be used for applications that require stable voltage.

In the embodiment depicted in FIG. 1, the switched resistor 104 is electrically connected between the input terminal 102 of the DC-DC converter 100 from which the input voltage, Vᵢₙ, is received and the output terminal 108 of the DC-DC converter from which the output voltage, Vₒᵤₜ, is output. The switched resistor can exhibit different impedance values in a switched on status (low impedance value) and a switched off status (high impedance value). In some embodiments, the switched resistor is implemented using a transistor. In these embodiments, when the transistor is switched on (i.e., closed or conductive), the transistor exhibits a smaller impedance value, and when the transistor is switched off (i.e., open or non-conductive), the transistor exhibits a larger impedance value.

In the embodiment depicted in FIG. 1, the comparator 106 is configured to compare the output voltage, Vₒᵤₜ, with the reference voltage, V_{ref}, and to switch on or off the switched resistor 104 based on the comparison between the output voltage, Vₒᵤₜ, and the reference voltage, V_{ref}. The comparator may be implemented using a differential amplifier or an operational amplifier. The comparator can operate based on the clock signal, CLK. For example, the comparator compares the output voltage, Vₒᵤₜ, with the reference voltage, V_{ref}, during each clock period of the clock signal, CLK, and switches on or off the switched resistor 104 based on the comparison between the output voltage, Vₒᵤₜ, and the reference voltage, V_{ref}, for the respective clock period. In some embodiments, the comparator compares the output voltage, Vₒᵤₜ, with the reference voltage, V_{ref}, during a clock period of the clock signal, CLK, and if the output voltage, Vₒᵤₜ, is higher than the reference voltage, V_{ref}, the comparator switches off the switched resistor for the clock period. If the output voltage, Vₒᵤₜ, is lower than the reference voltage, V_{ref}, the comparator switches on the switched resistor for the clock period. In some embodiments, the comparator is configured to switch on or off the switched resistor based on the comparison between the output voltage, Vₒᵤₜ, and the reference voltage, V_{ref}, in response to a signal edge of the clock signal, CLK. The signal edge of the clock signal may be a rising signal edge or a falling signal edge. The comparator may switch on the switched resistor for a clock period of the clock signal, CLK, when the output voltage, Vₒᵤₜ, is lower than the reference voltage, V_{ref}, at the signal edge of the clock signal, CLK, and switch off the switched resistor for a clock period when the output voltage, Vₒᵤₜ, is higher than the reference voltage, V_{ref}, at the signal edge of the clock signal, CLK. The comparator can switch on or off the switched resistor by supplying an enablement signal or a disablement signal to the switched resistor, respectively. In some embodiments, the switched resistor is implemented using a transistor and the comparator switches on or off the switched resistor by supplying a particular voltage to a gate terminal or to a base terminal of the transistor, respectively.

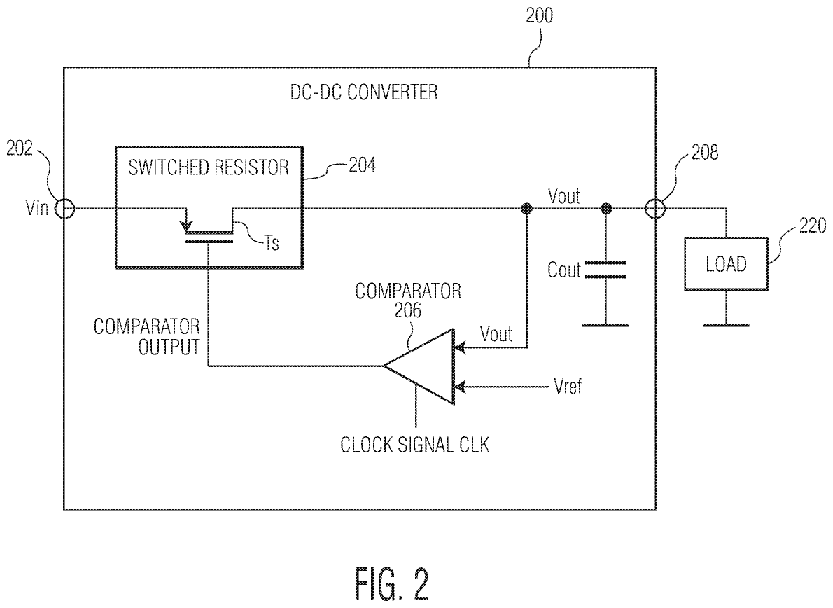

FIG. 2 depicts a DC-DC converter 200, which is an embodiment of the DC-DC converter 100 depicted in FIG. 1. The DC-DC converter converts an input DC voltage, Vᵢₙ, into an output DC voltage, Vₒᵤₜ, for a load 220. In the embodiment depicted in FIG. 2, the DC-DC converter includes an input terminal 202, a switched resistor 204 that is implemented as a transistor, “T_{S},” a comparator 206, an output terminal 208, and a capacitor, “Cₒᵤₜ.” The capacitor, Cₒᵤₜ, can keep the voltage ripple of the output DC voltage, Vₒᵤₜ, below a certain threshold. The DC-DC converter 200 depicted in FIG. 2 is one possible embodiment of the DC-DC converter 100 depicted in FIG. 1. However, the DC-DC converter 100 depicted in FIG. 1 is not limited to the embodiment shown in FIG. 2.

The DC-DC converter 200 can deal with an abrupt increase or decrease in the output DC voltage, Vₒᵤₜ, of the DC-DC converter caused by a loadstep in the load current (e.g., an instantaneous increase of the load current) in a timely manner. In some embodiments, when an instantaneous increase of the load current occurs, the DC-DC converter depicted in FIG. 2 switches on the transistor, T_{S}, when or immediately after (e.g., within a threshold time such as 1 microsecond) the comparator 206 detects a drop in the output DC voltage, Vₒᵤₜ. Compared to a typical DC-DC converter that reacts to an abrupt increase or decrease in its output voltage in a slow pace (e.g., by adjusting its impedance in small steps), the DC-DC converter depicted in FIG. 2 can adjust the output DC voltage, Vₒᵤₜ, (e.g., to keep the output DC voltage, Vₒᵤₜ, stable) more quickly. Consequently, the DC-DC converter depicted in FIG. 2 can be used for applications that require stable voltage.

In the embodiment depicted in FIG. 2, the transistor, T_{S}, is electrically connected between the input terminal 102 of the DC-DC converter 100 from which the input voltage, Vᵢₙ, is received and the output terminal 108 of the DC-DC converter from which the output voltage, Vₒᵤₜ, is output. The transistor, T_{S}, exhibits different impedance values in a switched on status and a switched off status. Specifically, when the transistor, T_{S}, is switched on, the transistor exhibits a smaller impedance value, and when the transistor, T_{S}, is switched off, the transistor exhibits a larger impedance value.

In the embodiment depicted in FIG. 2, the comparator 206 is configured to compare the output voltage, Vₒᵤₜ, with a reference voltage, V_{ref}, during each clock period of a clock signal, CLK, and switches on or off the transistor, T_{S}, based on the comparison between the output voltage, Vₒᵤₜ, and the reference voltage, V_{ref}, for the respective clock period. The comparator may be implemented using a differential amplifier or an operational amplifier. In some embodiments, the comparator compares the output voltage, Vₒᵤₜ, with the reference voltage, V_{ref}, during a clock period of the clock signal, CLK, and if the output voltage, Vₒᵤₜ, is higher than the reference voltage, V_{ref}, the comparator switches off the transistor, T_{S}, for that clock period. If the output voltage, Vₒᵤₜ, is lower than the reference voltage, V_{ref}, the comparator switches on the transistor, T_{S}, for that clock period. The comparator can switch on the transistor, T_{S}, by supplying an enablement signal to a gate terminal or a base terminal of the transistor and switch off the transistor, T_{S}, by supplying a disablement signal to a gate terminal or a base terminal of the transistor. For example, with respect to FIG. 2, if the transistor, T_{S}, is a bipolar junction transistor (BJT), the comparator switches on the transistor, T_{S}, by supplying an enablement signal to the base terminal of the transistor and switches off the transistor, T_{S}, by supplying a disablement signal to the base terminal of the transistor. If the transistor, T_{S}, is a field-effect transistor (FET), the comparator switches on the transistor, T_{S}, by supplying an enablement signal to the gate terminal of the transistor and switches off the transistor, T_{S}, by supplying a disablement signal to the gate terminal of the transistor.

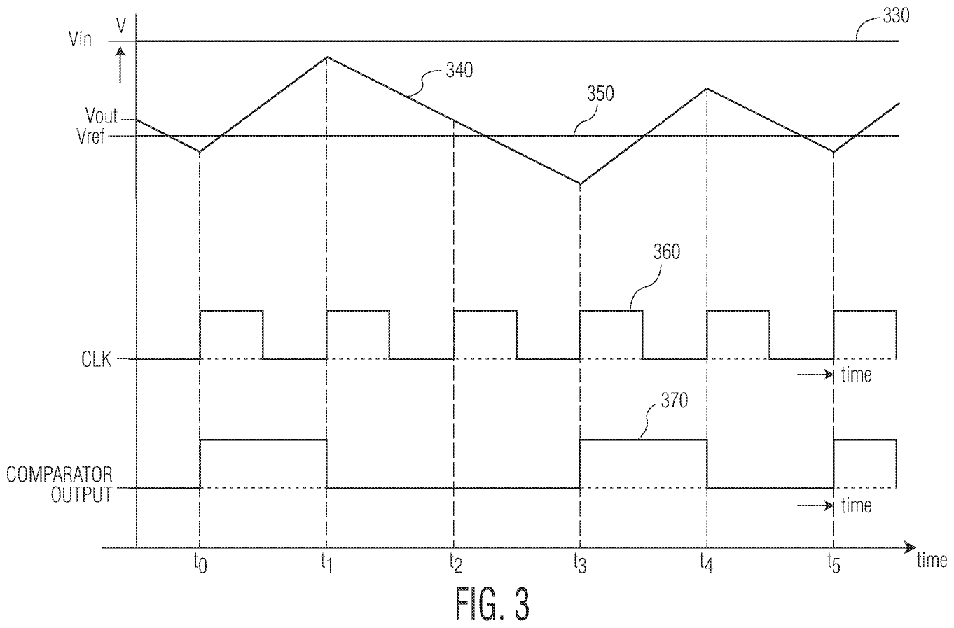

FIG. 3 illustrates a signal timing diagram that corresponds to an operation of the DC-DC converter 200 depicted in FIG. 2. In the signal timing diagram illustrated in FIG. 3, the input DC voltage, Vᵢₙ, the output DC voltage, Vₒᵤₜ, the reference voltage, V_{ref}, the clock signal, CLK, and an output of the comparator 206 (also referred to as the comparator output) are shown as signal lines 330, 340, 350, 360, 370, respectively, in multiple clock cycles of the DC-DC converter 200. Initially, the output DC voltage, Vₒᵤₜ, drops due to the load current through the load 220. At time point, t₀, the clock signal, CLK, has a rising edge and the output DC voltage, Vₒᵤₜ, is lower than the reference voltage, Vref, and the comparator output becomes logic high (e.g., “1”). Consequently, at time point, t₀, the transistor, T_{S}, is turned on (conducting) for the clock period between time point, t₀, and time point, t₁, and the output DC voltage, Vₒᵤₜ, starts to increase. At time point, t₁, the clock signal, CLK, has another rising edge and the output DC voltage, Vₒᵤₜ, is higher than the reference voltage, Vref, and the comparator output becomes logic low (e.g., “0”). Consequently, at time point, t₁, the transistor, T_{S}, is turned off (non-conducting) for the clock period between time point, t₁, and time point, t₂, and the output DC voltage, Vₒᵤₜ, starts to decrease. At time point, t₂, the clock signal, CLK, has another rising edge and the output DC voltage, Vₒᵤₜ, is still higher than the reference voltage, Vref, and the comparator output is maintained at logic low (e.g., “0”). Consequently, at time point, t₂, the transistor, T_{S}, stays turned off for the clock period between time point, t₂, and time point, t₃, and the output DC voltage, Vₒᵤₜ, keeps decreasing. At time point, t₃, the clock signal, CLK, has another rising edge and the output DC voltage, Vₒᵤₜ, is lower than the reference voltage, Vref, and the comparator output becomes logic high (e.g., “1”). Consequently, at time point, t₃, the transistor, T_{S}, is turned on for the clock period between time point, t₃, and time point, t₄, and the output DC voltage, Vₒᵤₜ, starts to increase. At time point, t₄, the clock signal, CLK, has another rising edge and the output DC voltage, Vₒᵤₜ, is higher than the reference voltage, Vref, and the comparator output becomes logic low (e.g., “0”). Consequently, at time point, t₄, the transistor, T_{S}, is turned off (non-conducting) for the clock period between time point, t₄, and time point, t₅, and the output DC voltage, Vₒᵤₜ, starts to decrease. At time point, t₅, the clock signal, CLK, has another rising edge and the output DC voltage, Vₒᵤₜ, is lower than the reference voltage, Vref, and the comparator output becomes logic high (e.g., “1”). Consequently, at time point, t₅, the transistor, T_{S}, is turned on for the clock period starting from time point, t₅, and the output DC voltage, Vₒᵤₜ, starts to increase. Eventually, the output DC voltage, Vₒᵤₜ, is within a voltage range (also referred to as a ripple range) of the reference voltage, Vref. The maximum value of the ripple range can be determined by the difference between the input DC voltage, Vᵢₙ, and the output DC voltage, Vₒᵤₜ, the resistance value of the transistor, T_{S}, when turned on, the capacitance value of the capacitor, Cₒᵤₜ, and/or the clock frequency of the clock signal, CLK.

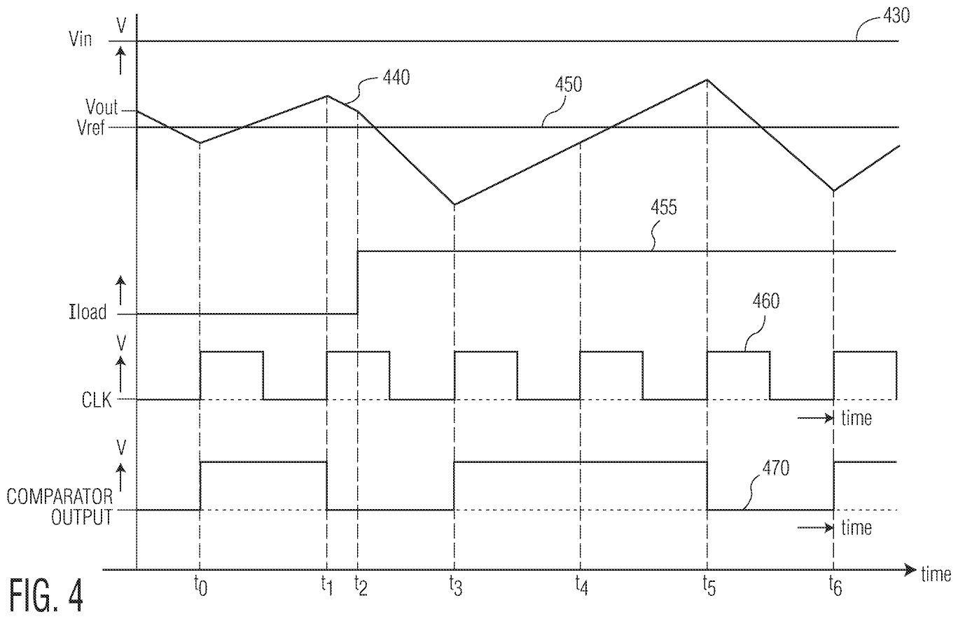

FIG. 4 illustrates a signal timing diagram that corresponds to an operation of the DC-DC converter 200 depicted in FIG. 2 in which a loadstep (e.g., an instantaneous increase of the load current, I_{load}) occurs. In the signal timing diagram illustrated in FIG. 3, the input DC voltage, Vᵢₙ, the output DC voltage, Vₒᵤₜ, the reference voltage, V_{ref}, the load current, I_{load}, through the load 220, the clock signal, CLK, and an output of the comparator 206 (also referred to as the comparator output) are shown as signal lines 430, 440, 450, 455, 460, 470, respectively, in multiple clock cycles of the DC-DC converter 200. At time point, t₀, the clock signal, CLK, has a rising edge and the output DC voltage, Vₒᵤₜ, is lower than the reference voltage, Vref, and the comparator output becomes logic high (e.g., “1”). Consequently, at time point, t₀, the transistor, T_{S}, is turned on (conducting) for the clock period between time point, t₀, and time point, t₁, and the output DC voltage, Vₒᵤₜ, starts to increase. At time point, t₁, the clock signal, CLK, has another rising edge and the output DC voltage, Vₒᵤₜ, is higher than the reference voltage, Vref, and the comparator output becomes logic low (e.g., “0”). Consequently, at time point, t₁, the transistor, T_{S}, is turned off (non-conducting) for the clock period between time point, t₁, and time point, t₃, and the output DC voltage, Vₒᵤₜ, starts to decrease. A change of the load current, I_{load}, through the load 220 can affect the rate of change of the output DC voltage, Vₒᵤₜ, of the DC-DC converter 200. At time point, t₂, a loadstep occurs, and as a result, the output DC voltage, Vₒᵤₜ, decreases at a faster rate until the next rising clock edge at time point, t₃. The maximum reduction of the output DC voltage, Vₒᵤₜ, can be determined by the resistance value of the transistor, T_{S}, when turned on, the capacitance value of the capacitor, Cₒᵤₜ, the clock frequency of the clock signal, CLK, and/or the difference between the input DC voltage, Vᵢₙ, and the output DC voltage, Vₒᵤₜ. Similarly, after an instantaneous decrease in the load current, I_{load}, the output DC voltage, Vₒᵤₜ, increases faster at a faster rate than between time point, t₁, and time point, t₂, within a clock period of the clock signal, CLK (i.e., the clock period starting from time point, t₁).

At time point, t₃, the clock signal, CLK, has another rising edge and the output DC voltage, Vₒᵤₜ, is lower than the reference voltage, Vref, and the comparator output becomes logic high (e.g., “1”). Consequently, at time point, t₃, the transistor, T_{S}, is turned on for the clock period between time point, t₃, and time point, t₄, and the output DC voltage, Vₒᵤₜ, starts to increase. At time point, t₄, the clock signal, CLK, has a rising edge and the output DC voltage, Vₒᵤₜ, is still lower than the reference voltage, Vref, and the comparator output becomes logic high (e.g., “1”). Consequently, at time point, t₄, the transistor, T_{S}, is kept on for the clock period between time point, t₄, and time point, t₅, and the output DC voltage, Vₒᵤₜ, continues to increase. At time point, t₅, the clock signal, CLK, has another rising edge and the output DC voltage, Vₒᵤₜ, is higher than the reference voltage, Vref, and the comparator output becomes logic low (e.g., “0”). Consequently, at time point, t₅, the transistor, T_{S}, is turned off (non-conducting) for the clock period between time point, t₅, and time point, t₆, and the output DC voltage, Vₒᵤₜ, starts to decrease. At time point, t₆, the clock signal, CLK, has a rising edge and the output DC voltage, Vₒᵤₜ, is lower than the reference voltage, Vref, and the comparator output becomes logic high (e.g., “1”). Consequently, at time point, t₆, the transistor, T_{S}, is turned on for the clock period starting from time point, t₆, and the output DC voltage, Vₒᵤₜ, starts to increase. Eventually, the output DC voltage, Vₒᵤₜ, is within a voltage range (also referred to as a ripple range) of the reference voltage, Vref.

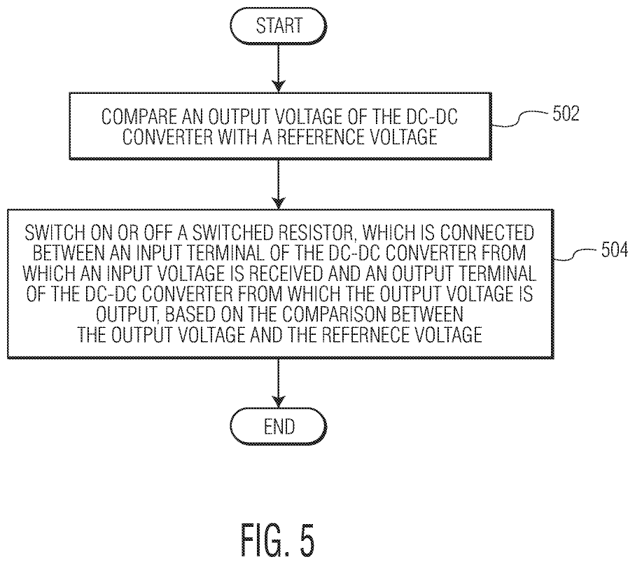

FIG. 5 is a process flow diagram of a method for operating a DC-DC converter in accordance with an embodiment of the invention. At block 502, an output voltage of the DC-DC converter is compared with a reference voltage. At block 504, a switched resistor, which is connected between an input terminal of the DC-DC converter from which an input voltage is received and an output terminal of the DC-DC converter from which the output voltage is output, is switched on or off based on the comparison between the output voltage and the reference voltage. The DC-DC converter may be the same as or similar to the DC-DC converter 100 depicted in FIG. 1 and/or the DC-DC converter 200 depicted in FIG. 2. The switched resistor may be the same as or similar to the switched resistor 104 depicted in FIG. 1 and/or the switched resistor 204 depicted in FIG. 2.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program. The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

1. A DC-DC converter, the DC-DC converter comprising:
a switched resistor comprising a transistor connected between an input terminal of the DC-DC converter from which an input voltage is received and an output terminal of the DC-DC converter from which an output voltage is output, wherein the transistor has a smaller impedance value when switched on and a larger impedance value when switched off; and
a comparator configured to
receive a clock signal, the output voltage, and a reference voltage,
compare the output voltage with the reference voltage in response to a signal edge of a clock signal, and
switch on or off the switched resistor based on the comparison between the output voltage and the reference voltage in response to the signal edge of the clock signal.

2. (canceled)

3. The DC-DC converter of claim 1, wherein a base terminal or a gate terminal of the transistor is connected to an output terminal of the comparator.

4. The DC-DC converter of claim 1, wherein the comparator is further configured to switch on the switched resistor for a clock period when the output voltage is lower than the reference voltage.

5. The DC-DC converter of claim 1, wherein the comparator is further configured to switch off the switched resistor for a clock period when the output voltage is higher than the reference voltage.

6. (canceled)

7. The DC-DC converter of claim 1, wherein the comparator is further configured to switch on or off the switched resistor for a clock period of the clock signal based on the comparison in response to the signal edge of the clock signal.

8. The DC-DC converter of claim 1, wherein the comparator is further configured to switch on or off the switched resistor for a clock period of the clock signal based on the comparison.

9. The DC-DC converter of claim 8, wherein the comparator is further configured to switch on the switched resistor for the clock period when the output voltage is lower than the reference voltage at the signal edge of the clock signal.

10. The DC-DC converter of claim 8, wherein the comparator is further configured to switch off the switched resistor for the clock period when the output voltage is higher than the reference voltage at the signal edge of the clock signal.

11. The DC-DC converter of claim 8, wherein the signal edge of the clock signal comprises a rising signal edge or a falling signal edge.

12. The DC-DC converter of claim 1, further comprising:
a capacitor connected between the output terminal and a fixed voltage.

13. A DC-DC converter, the DC-DC converter comprising:
a transistor connected between an input terminal of the DC-DC converter from which an input voltage is received and an output terminal of the DC-DC converter from which an output voltage is output, wherein the transistor has a smaller impedance value when switched on and a larger impedance value when switched off; and
a comparator configured to
receive a clock signal, the output voltage, and a reference voltage,
compare the output voltage with the reference voltage in response to a signal edge of the clock signal, and
switch on or off the transistor for a clock period of the clock signal based on the comparison between the output voltage and the reference voltage.

14. The DC-DC converter of claim 13, wherein the comparator is further configured to switch on the transistor for the clock period when the output voltage is lower than the reference voltage at the signal edge of the clock signal.

15. The DC-DC converter of claim 13, wherein the comparator is further configured to switch off the transistor for a clock period when the output voltage is higher than the reference voltage at the signal edge of the clock signal.

16. The DC-DC converter of claim 13, wherein a base terminal or a gate terminal of the transistor is connected to an output terminal of the comparator.

17. The DC-DC converter of claim 13, wherein the signal edge of the clock signal comprises a rising signal edge or a falling signal edge.

18. The DC-DC converter of claim 13, further comprising:
a capacitor connected between the output terminal and a fixed voltage.

19. A method for operating a DC-DC converter, the method comprising:
comparing an output voltage of the DC-DC converter with a reference voltage in response to a signal edge of a clock signal; and
switching on or off a switched resistor comprising a transistor, connected between an input terminal of the DC-DC converter from which an input voltage is received and an output terminal of the DC-DC converter from which the output voltage is output, based on the comparison between the output voltage and the reference voltage, wherein the transistor has a smaller impedance value when switched on and a larger impedance value when switched off;
switching on the switched resistor for a first clock period when the output voltage is lower than the reference voltage at a first signal edge of the clock signal; and
switching off the switched resistor for a second clock period when the output voltage is higher than the reference voltage at a second signal edge of the clock signal.

20. (canceled)
